(19) United States
(12) Patent Application Publication
(10) Pub. No.: US 2014/0122857 A1
(43) Pub. Date: May 1, 2014

(54) APPARATUS, SYSTEM AND METHOD FOR MOTHERBOARD PERSONALIZATION

(71) Applicant: LENOVO (SINGAPORE) PTE, LTD., (US)

(72) Inventors: Richard Todd Wall, Garner, NC (US); David Edward Erickson, Cary, NC (US); Philip John Jakes, Durham, NC (US); Randall Scott Springfield, Chapel Hill, NC (US)

(73) Assignee: LENOVO (SINGAPORE) PTE, LTD., New Tech Park (SG)

(21) Appl. No.: 13/660,714

(22) Filed: Oct. 25, 2012

(51) Int. Cl. G06F 9/445

(52) U.S. Cl. CPC G06F 9/44557
USPC 713/2

(57) ABSTRACT

An apparatus, system, and method are disclosed for motherboard personalization. An access module 202 may detect whether a removable storage device 504 that stores personalization data 702 is installed 804 in a motherboard socket 506 during a boot sequence of a computer 110 and if so read 806 the personalization data 702. An analysis module 204 may determine if motherboard data 704 has been initialized 810, and if so compare 814 the personalization data 702 with the motherboard data 704, and if not initialize the motherboard data 704 with the personalization data 702, and terminate 816 the boot sequence if the motherboard data 704 does not match 814 the personalization data 702. In addition, a programming module 106 may store 918 the personalization data 702 into the removable storage device 504 and a reset module 108 may clear 1010 initialization of the motherboard data 704 in a secure vendor-controlled manner.

### BACKGROUND

1. Field

The subject matter disclosed herein relates to the manufacture and servicing of data processing systems and more particularly relates to motherboard configuration.

2. Description of the Related Art

Configuration of motherboards is becoming increasingly complex, with options for enabling or disabling Active Management Technology (“AMT”) and Trusted Platform Module (“TPM”), and now substantial complexity increase with Original Equipment Manufacturer (“OEM”) activation markers for various operating system versions.

For security and licensing reasons, these features cannot be set by the end user or servicer, but must be set at point of manufacture. This is driving configuration complexity in manufacturing environments and driving substantial complexity for servicers as there are now as many as 20 different software configurations required to be provided as replacements for each different motherboard.

Motherboard configuration is currently performed on the manufacturing line. This means that motherboards have to be preconfigured at the factory, and all the various combinations created as separate Field Replaceable Unit (“FRU”) numbers, leading to substantial logistical complexity and high inventory costs for spare parts. This will become even more costly and complex as new operating systems and features are introduced.

### BRIEF SUMMARY

Based on the foregoing discussion, the inventors have recognized that a long-felt unmet need for an apparatus, system, and method that personalize a motherboard. Beneficially, such an apparatus, system, and method would reduce the cost and complexity of motherboard configuration and Field Replaceable Units (“FRU”) stock in inventory.

The embodiments of the present invention have been developed in response to the present state of the art, and in particular, in response to the problems and needs in the art hitherto proven intractable under currently available motherboard configuration. Accordingly, the embodiments have been developed to provide a method, apparatus, and system for motherboard personalization that overcome many or all of the above-discussed shortcomings in the art.

The apparatus to personalize a motherboard is provided with a plurality of modules configured to functionally execute the necessary steps. These modules in the described embodiments include an access module that detects whether a removable storage device that stores personalization data is installed in a motherboard socket during a boot sequence of a computer and reads the personalization data from the removable storage device if installed, an analysis module that determines if motherboard data has been initialized and compares the personalization data with the motherboard data if the motherboard data has been initialized, and an initialization module that initializes the motherboard data with the personalization data if the motherboard data has not been initialized and terminates the boot sequence if the motherboard data does not match the personalization data.

In one embodiment, the personalization data may comprise one or more of machine type, model, serial number, universal unique identifier, operating system marker(s), Advanced Encryption Standard enablement, Active Management Technology enablement, Trusted Platform Module enablement, and the like. The personalization data further may comprise writeable data that is not compared with the motherboard data.

In a further embodiment, the writeable data may comprise system data comprising firmware data comprising Complementary Metal Oxide Semiconductor (“CMOS”) data. The writeable data may also comprise user-definable data.

A system is also presented to personalize a motherboard. The system may be embodied by the removable storage device, the motherboard socket, the computer and the foregoing apparatus for motherboard personalization. In particular, the system, in one embodiment, includes a physically lockable part that locks the removable storage device into the motherboard socket in a secure vendor-controlled manner.

In one embodiment, the system may further comprise a programming module that stores the personalization data into the removable storage device in a secure vendor-controlled manner. In a further embodiment, the secure vendor-controlled manner may comprise encrypting the personalization data. In another embodiment, the system may further comprise a reset module that clears initialization of the motherboard data in a secure vendor-controlled manner.

A method is also presented for personalizing a motherboard. The method in the disclosed embodiments substantially includes the steps necessary to carry out the functions presented above with respect to the operation of the described apparatus and system. In one embodiment, the method includes detecting whether a removable storage device that stores personalization data is installed in a motherboard socket during a boot sequence of a computer, reading the personalization data from the removable storage device if installed, determining if motherboard data has been initialized, comparing the personalization data with the motherboard data if the motherboard data has been initialized, initializing the motherboard data with the personalization data if the motherboard data has not been initialized, and terminating the boot sequence if the motherboard data does not match the personalization data.

In an embodiment, the method also may include programming the removable storage device by storing the personalization data into the removable storage device in a secure vendor-controlled manner, and/or writing writeable data that is not compared with the motherboard data into the removable storage device, the writeable data comprising one or more of system data and user-definable data. In a further embodiment, the personalization data can be stored only once and/or the writeable data can only be written once.

In one embodiment, storing may further comprise encrypting the personalization data and reading may further comprise decrypting the personalization data. In another embodiment, the method may further comprise clearing initialization of the motherboard data in a secure vendor-controlled manner.

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of the embodiments as set forth hereinafter.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system of the present invention;

FIG. 2 is a schematic block diagram illustrating a motherboard personalization apparatus;

FIG. 3 is a schematic block diagram illustrating a possible computer hardware platform upon which the present invention may be at least in part deployed;

FIG. 4 is a schematic block diagram of a possible computer including a software stack in which the present invention may at least in part reside;

FIG. 5 is a schematic block diagram of a motherboard showing one embodiment of a removable storage device;

FIG. 6 is a schematic block diagram illustrating an embodiment of a removable storage device in a motherboard socket secured by a physically lockable part;

FIG. 7 is a more detailed schematic block diagram of one embodiment of the motherboard personalization system;

FIG. 8 is a schematic flow chart diagram illustrating one embodiment of a method for motherboard personalization in accordance with the present invention;

FIG. 9 is a schematic flow chart diagram illustrating one embodiment of a method for programming the removable storage device; and

FIG. 10 is a schematic flow chart diagram illustrating one embodiment of a method for resetting the motherboard personalization.

### DETAILED DESCRIPTION

As will be appreciated by one skilled in the art, aspects of the embodiments may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable medium(s).

Any combination of one or more computer readable medium(s) may be utilized. The computer readable medium may be a computer readable signal medium or a computer readable storage medium. The computer readable medium may be a tangible computer readable storage medium storing the computer readable code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Computer readable program code embodied on a computer readable medium may be transmitted using any appropriate medium, including but not limited to wireless, wireline, optical fiber cable, RF, etc., or any suitable combination of the foregoing.

Computer readable program code for carrying out operations for embodiments may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments. It will be understood that each block of the schematic flowchart diagrams and/or schematic block diagrams, and combinations of blocks in the schematic flowchart diagrams and/or schematic block diagrams, can be implemented by computer readable program code. These computer readable program code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

The proposed solution to the problems with the current motherboard configuration process is the introduction of a compact, low-cost removable storage device on the motherboard to store all of the personalization information currently loaded on the manufacturing line, such as machine type and model (“MTM”), serial number (“S/N”), universal unique identifier (“UUID”), operating system (“OS”) marker(s), Advanced Encryption Standard (“AES”) enablement, Active Management Technology (“AMT”) enablement, Trusted Platform Module (“TPM”) enablement, and the like, which would all be loaded into the device.

When a servicer goes to replace a system's motherboard, they would just move the device from the old motherboard to the new motherboard. A rebinding process would take place which loads all the personalization data to the new FRU motherboard, including the marker file. No Basic Input/Output System (“BIOS”) Reference Diskette would be needed to update the MTM, S/N and UUID information. It would all be automatic.

The old motherboard would be unusable without the device being installed, and would be returned to the factory via the normal returns process where it could be repaired, refurbished, and restocked. As few as just one motherboard FRU would be needed in FRU stock, as opposed to four, sixteen, twenty, or more. There would be little reason to track replacement parts, unless the inexpensive removable storage device becomes damaged, which would constitute a small percentage as the FRU complexity is greatly reduced.

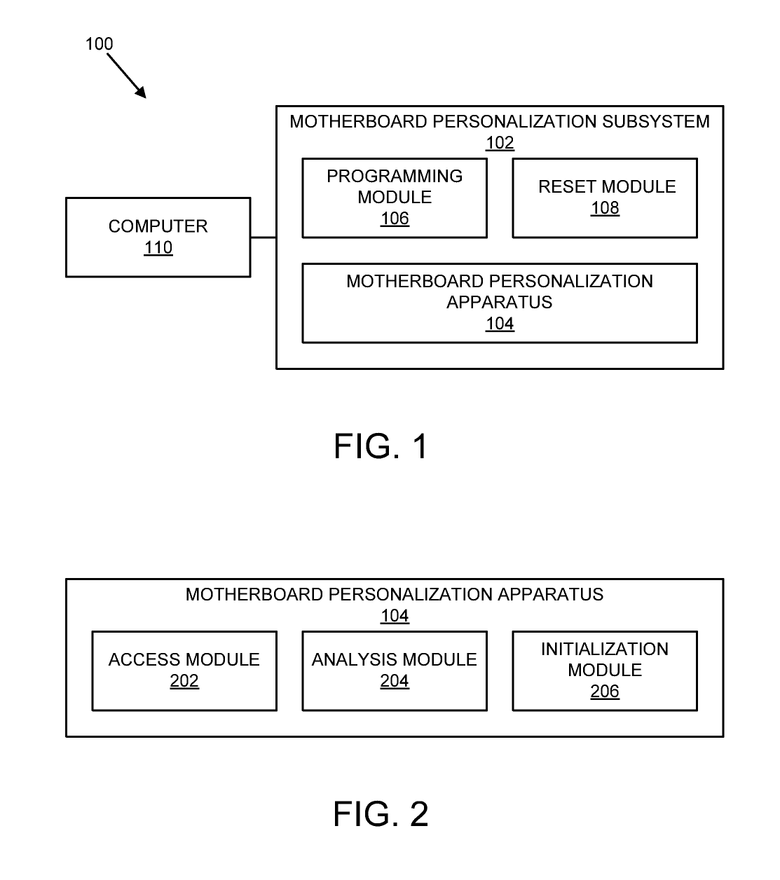

FIG. 1 is a schematic block diagram illustrating a system 100 of the present invention, comprising a computer 110 and a motherboard personalization subsystem 102. The subsystem 102 further comprises a motherboard personalization apparatus 104, a programming module 106, and a reset module 108. In an embodiment, the foregoing components of the subsystem 102 may be fully or partially implemented within a hardware platform and/or a software stack of the computer 110.

The apparatus 104 may activated during a boot sequence of the computer 110, reading personalization data from a removable storage device, comparing the personalization data with motherboard data if initialized, initializing the motherboard data if not initialized, and terminating the boot sequence if the motherboard data does not match the personalization data. Apparatus 104 may be employed whenever motherboard personalization is required in order to effect a given operation of the system 100. Operations requiring motherboard personalization may include initial configuration of the computer 110 in manufacturing, validation of the configuration during a boot sequence of the computer 110, hardware or software upgrades of the computer 110, repair or refurbishment of the computer 110, and the like.

The programming module 106 may store personalization data into the removable storage device in a secure vendor-controlled manner, such as by encrypting the personalization data, by employing a dedicated programming device available only in a secure area on the vendor premises, and so forth. The programming module 106 may also write system data and/or user-definable data into the removable storage device.

The reset module 108 may clear initialization of the motherboard data in a secure vendor-controlled manner, such as by requiring a password known only to vendor personnel, by running confidential vendor firmware from removable media available only to vendor personnel for the purpose, and so on. Security for the whole process could be further enhanced in systems that support the TPM hierarchy.

FIG. 2 is a schematic block diagram illustrating a motherboard personalization apparatus 104, comprising an access module 202, an analysis module 204, and an initialization module 206. The access module 202 may read the personalization data from the removable storage device. The analysis module 204 may compare the personalization data with motherboard data if initialized. The initialization module 206 may initialize the motherboard data if not initialized and terminate the boot sequence if the motherboard data does not match the personalization data.

The access module 202 may detect whether the removable storage device that stores the personalization data is installed in a motherboard socket during the boot sequence of the computer 110 and read the personalization data from the removable storage device if installed. The detection of installation may comprise a mechanical and/or electronic sensor in the motherboard socket. Detection may further comprise inspection of the personalization data for validity after it has been read. In one embodiment, validity of the personalization data may be indicated by a flag or similarly abbreviated status indicator stored with the personalization data.

The analysis module 204 may determine if the motherboard data has been initialized and compare the personalization data with the motherboard data if the motherboard data has been initialized. Determination of initialization may comprise inspection of the motherboard data for validity. In one embodiment, validity of the motherboard data may be indicated by a flag or similarly abbreviated status indicator stored with the motherboard data. In an embodiment, the analysis module 204 may map the personalization and/or motherboard data into a common format for purposes of comparison. In a further embodiment, the data may be compressed and/or hashed to save storage space and/or expedite the comparison.

The initialization module 206 may initialize the motherboard data with the personalization data if the motherboard data has not been initialized and terminate the boot sequence if the motherboard data does not match the personalization data. Initialization may comprise copying the personalization data to the motherboard data. In one embodiment, initialization may comprise expanding or reformatting the personalization data to yield the motherboard data. In a further embodiment, initialization may comprise generating a flag or similarly abbreviated status indicator and storing it with the motherboard data. In an embodiment, termination may comprise displaying an error message. It may further comprise providing an opportunity to correct any error(s) and retry the personalization.

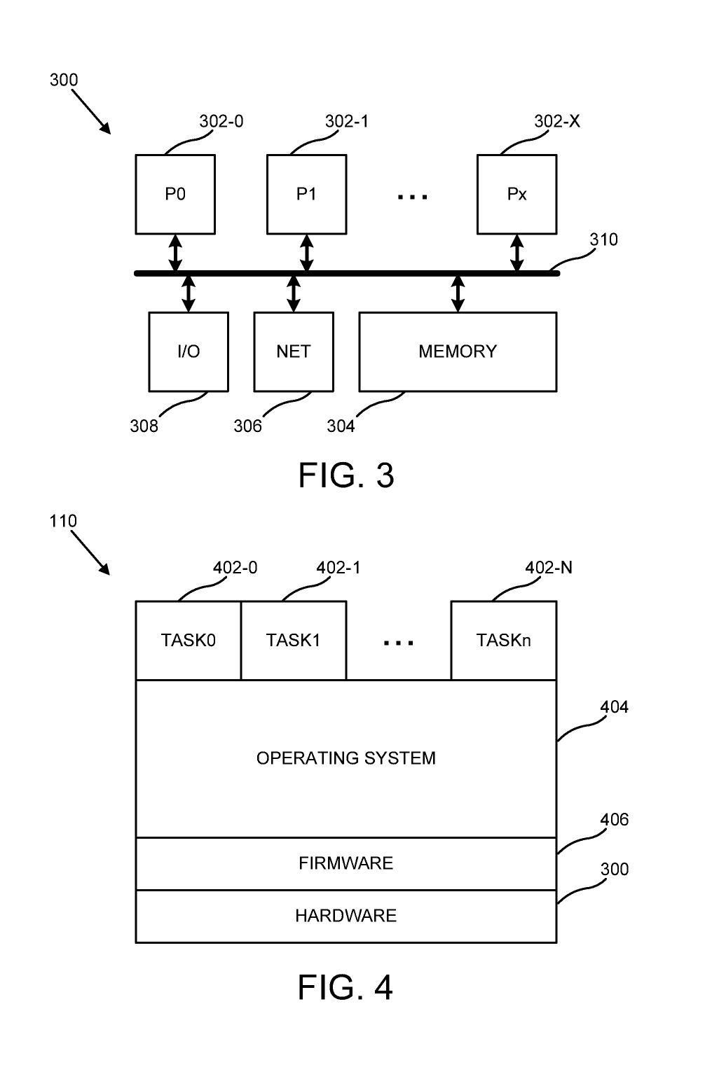

FIG. 3 illustrates a possible computer hardware platform 300 upon which the present invention may be at least in part deployed. The hardware platform 300 may include processor(s) 302, memory 304, a network interface 306, and an I/O (Input/Output) device interface 308, connected through a bus 310.

The hardware platform 300 may be of any form factor or type, including an embedded system, a handheld, a notebook, a personal computer, a minicomputer, a server, a mainframe, a supercomputer, and the like.

The processor(s) 302 may be present in any quantity, including a uniprocessor, and may have any instruction set architecture. In an embodiment, the processor(s) 302 may have one or more levels of dedicated or shared caches. Possible physical implementations may include multi-chip, single chip, multi-core, hyperthreaded processors, and the like.

The memory 304 may be of any size or organization and may include both read/write and read-only sections. It may also include both global and local sections, and may support both uniform and non-uniform access. It may incorporate memory-mapped I/O and direct memory access. It may support cache coherency, including directory-based and snoop-based protocols.

The network interface 306 may support any network protocol or architecture. It may support both wireless and hard-wired network connections. It may comprise Ethernet, Token Ring, System Network Architecture (“SNA”), and the like. In one embodiment, it may be integrated with the I/O device interface 308.

The I/O device interface 308 may be driven primarily by the processor(s) 302 or may incorporate an independent I/O processor subsystem. It may comprise Peripheral Component Interconnect (“PCI”), Small Computer System Interface (“SCSI”), Fiberchannel (“FC”), Enterprise System Connection (“ESCON”), ESCON over Fiberchannel (“FICON”), and the like. In an embodiment, it may include dedicated local I/O devices.

The bus 310 may comprise one or more of a variety of physical and logical topologies. It may be parallel or serial. It may be unidirectional or bidirectional. It may be flat or hierarchical. It may comprise a full or partial crossbar. It may comprise multiple bridged busses. In an embodiment, the bus 310 may comprise a high-speed internal network.

FIG. 4 is a diagram of a possible computer 400 including a software stack in which the present invention may at least in part reside. The software stack may include task(s) 402, hosted on an operating system 404, enabled by firmware 406, running on a hardware platform 300 of which the configuration of FIG. 3 is representative.

The task(s) 402 may include both user- and system-level tasks. They may be interactive or batch. They may run in the foreground or background. User-level task(s) 402 may include applications, programs, jobs, middleware, and the like. System-level task(s) 402 may include services, drivers, daemons, utilities, and the like.

The operating system 404 may be of any type and version and in any state. Types may include Unix, Linux, Windows, Mac, MVS, VMS, and the like. Versions may include Windows XP, Windows Vista, and the like. States may include a degree of customization, a mode of operation, a system preparation for setup, and the like. The operating system 404 may be single-user or multi-user. It may be single-tasking or multi-tasking. In an embodiment, the operating system 404 may be real-time. In another embodiment, the operating system 404 may be embedded.

The firmware 406 may comprise microcode, which may reside in a microstore of the processor(s) 302. In an embodiment, the firmware 406 may comprise low-level software, which may reside in memory 304. In one embodiment, the firmware 406 may comprise a rudimentary operating system 404. In a further embodiment, the firmware 406 may support virtualization so as to permit the concurrent operation of multiple operating systems 404 on a hardware platform 300.

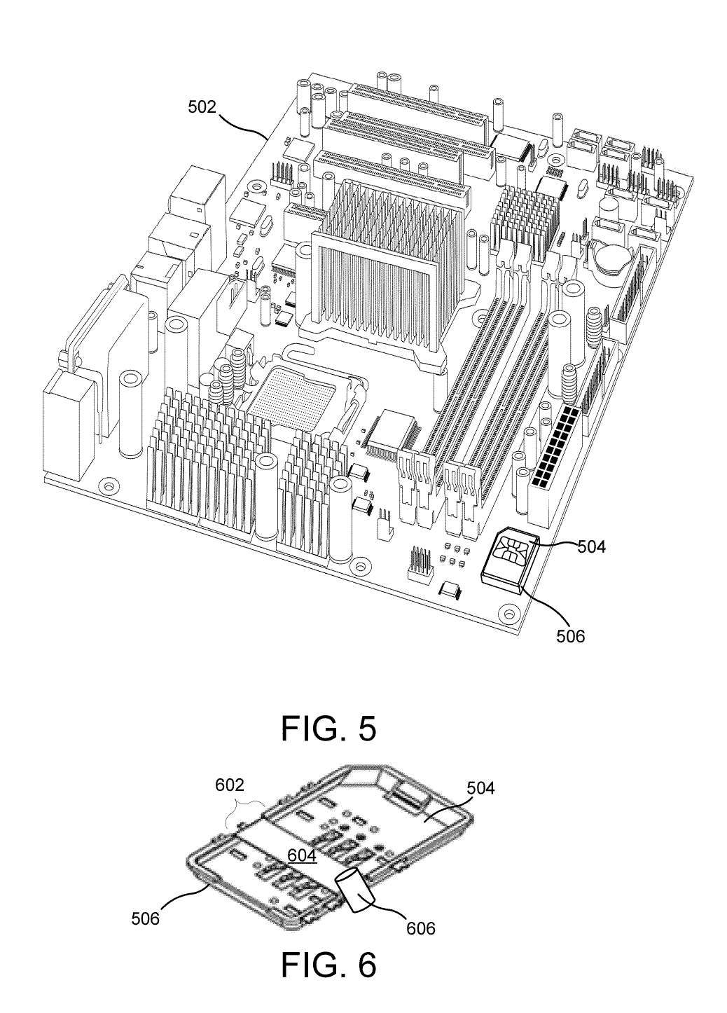

FIG. 5 is a schematic block diagram of a motherboard 502 showing one embodiment of a removable storage device 504 installed in a motherboard socket 506. The removable storage device 504 may be a Subscriber Information Module (“SIM”) card or the like. The device 504 may be substantially smaller and less expensive than the motherboard 502 to reduce the cost of manufacturing and stocking. Devices 504 may be partially or fully programmed on demand in a just-in-time fashion, or may be partially or fully pre-programmed with personalization data that corresponds to a predetermined Field Replaceable Unit (“FRU”) and kept in inventory accordingly.

FIG. 6 is a schematic block diagram illustrating an embodiment of the removable storage device 504 in the motherboard socket 506 secured by a physically lockable part 602 in a secure vendor-controlled manner. The shown embodiment comprises a clip 604 and a lock 606. Another embodiment may comprise a cover, and the clip or cover may be hinged. Yet another embodiment may comprise a slot, with or without a door or other hinged member to retain the device 504. A special key or tool available only to authorized vendor personnel may be required to operate the lock 606. The part 602 tamper-resistant or tamper-evident. The socket 506 may comprise one or more sensors by which the access module 202 can determine whether the part 602 is closed and/or locked. In another embodiment, the lock 606 may be electronically controlled.

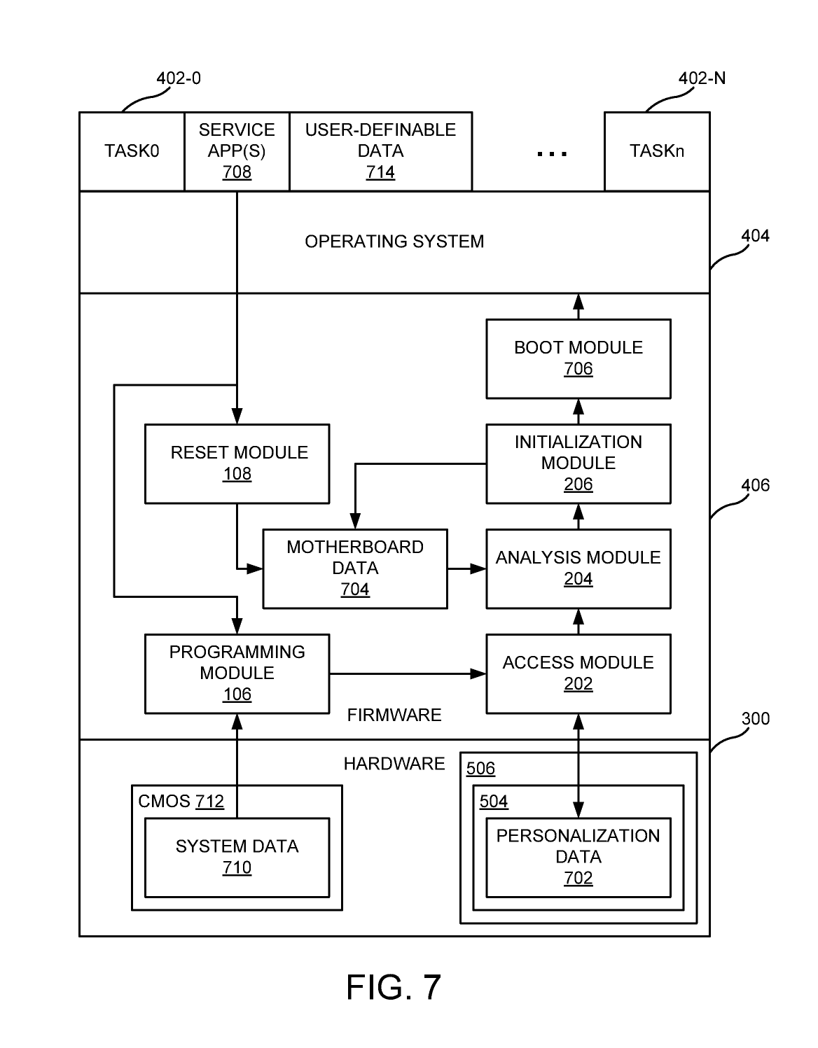

FIG. 7 is a more detailed schematic block diagram of one embodiment of the motherboard personalization system 100. Personalization data 702 resides in the removable storage device 504 installed in the motherboard socket 506 on the hardware platform 300, and may include information such as MTM, S/N, UUID, OS marker(s), AES enablement, AMT enablement, TPM enablement, and so forth. It may be read and written by the access module 202, which in turn provides it to the analysis module 204 to be compared with motherboard data 704. If the motherboard data 704 has not been initialized, then the personalization data 702 is passed along to the initialization module 206 to initialize the motherboard data 704. If the motherboard data 704 does not match the personalization data 702, then the initialization module 206 instructs the boot module 706 to terminate the boot sequence of the operating system 404.

Service application(s) 708 running as task(s) 402 that are available to appropriately authorized users may be used to control other auxiliary functions within the motherboard personalization subsystem 102. The programming module 106 may be instructed to store personalization data 702 into the removable storage device 504.

The programming module 106 may also write additional writeable data into the removeable storage device 504, such as system data 710 comprising firmware data residing in Complementary Metal Oxide Semiconductor (“CMOS”) 712 on the hardware platform 300. User-definable data 714 as specified by the appropriately authorized user(s) of the service application(s) 708 may also be included in the writeable data written by the programming module 106. The writeable data does not participate in the comparison that is performed by the analysis module 204, but may be used to re-initialize the system data 710 and/or the user-definable data 714 when the initialization module 206 initializes the motherboard data 704, or at other times such as if the system data 710 or the user-definable data 714 become lost or corrupted.

The reset module 108 may be instructed by the service application(s) 708 to clear initialization of the motherboard data 704. In one embodiment, the reset module 108 may erase the motherboard data 704. In a further embodiment, the reset module 108 may clear a flag or other initialization status indicator associated with the motherboard data 704.

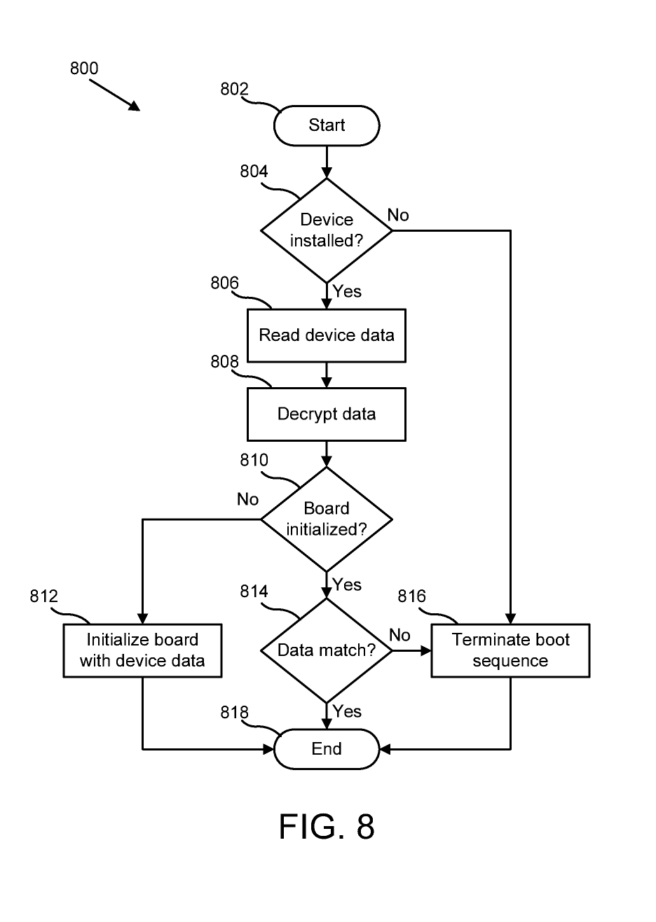

FIG. 8 is a schematic flow chart diagram illustrating one embodiment of a method 800 for motherboard personalization in accordance with the present invention. The method 800 starts 802 and the access module 202 detects whether the removable storage device 504 is installed 804 in the motherboard socket 506 during a boot sequence of the computer 110. If the device 504 is installed 804 then the access module 202 reads 806 the personalization data 702 from the device 504. In an embodiment, the access module 202 may also decrypt 808 the personalization data 702. If the motherboard data 704 has not been initialized 810 then the initialization module 206 initializes 812 the motherboard data 704. The analysis module 204 compares the personalization data 702 with the motherboard data 704 and if they match 814 then the method 800 ends 818. If they do not match 814 or if the device 504 is not installed 804 then the initialization module 206 terminates 816 the boot sequence and the method 800 ends 818.

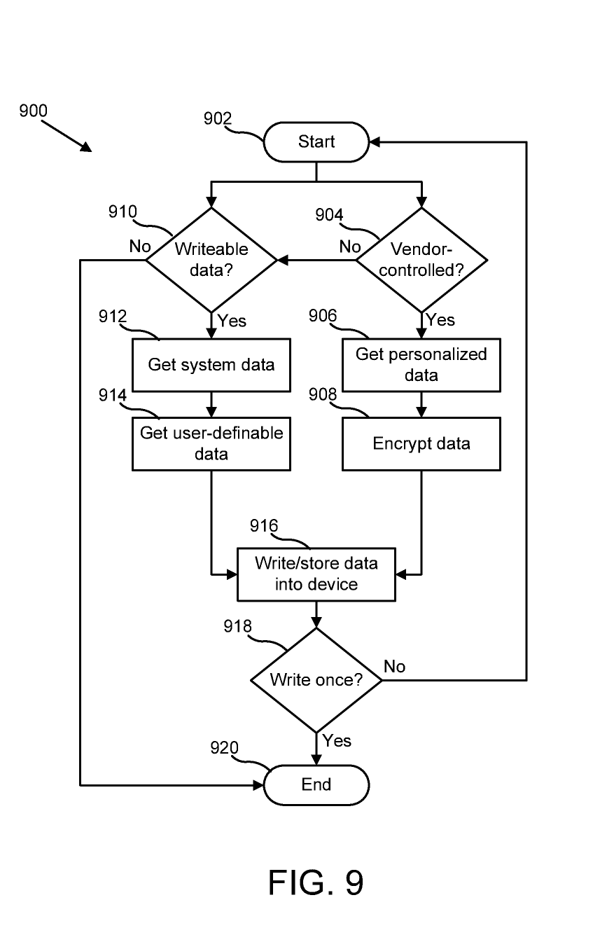

FIG. 9 is a schematic flow chart diagram illustrating one embodiment of a method 900 for programming the removable storage device 504. The method 900 starts 902 and if the programming module 106 is operating in a vendor-controlled manner 904 then it gets 906 the personalization data 702. In an embodiment, the programming module 106 may encrypt 908 the personalization data 702. If there is writeable data 910 then the programming module gets 912 system data 710 and/or gets 914 user-definable data 714. The programming module 106 then writes and/or stores 916 the writeable data and/or the personalization data 702 into the removable storage device 504. If the programming module is not operating in a vendor-controlled manner 904 and there is no writeable data 910 then the method 900 ends 920. If personalization data and the writeable data can only be stored/written once 918 then the method 900 ends 920. Otherwise, the method 900 may be started 902 again in the future as needed to re-program the removable storage device 504.

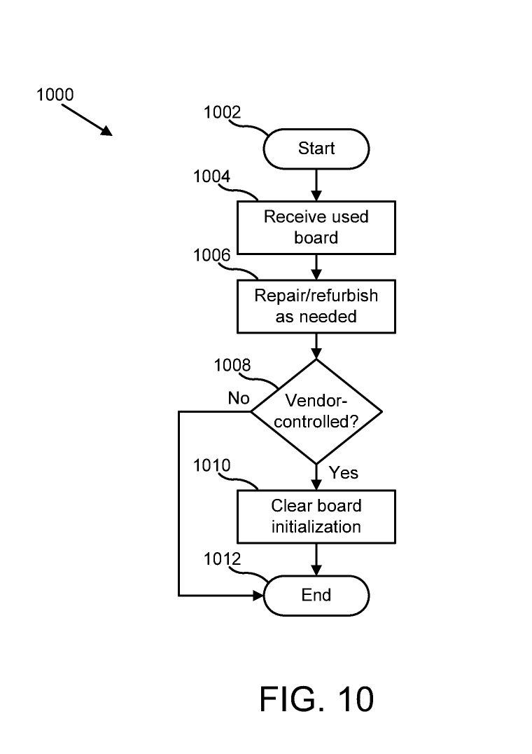

FIG. 10 is a schematic flow chart diagram illustrating one embodiment of a method 1000 for resetting the motherboard personalization. The method 1000 starts and a used motherboard 502 that was previously initialized 812 is received 1004. The board 502 may be repaired or refurbished 1006 as needed. If the reset module 108 is operating in a vendor-controlled manner 1008 then the motherboard initialization is cleared 1010 and the method 1000 ends 1012. If the reset module 108 is not operating in a vendor-controlled manner 1008 then the method 1000 ends 1012.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
an access module that detects whether a removable storage device that stores personalization data is installed in a motherboard socket during a boot sequence of a computer and reads the personalization data from the removable storage device if installed;
an analysis module that determines if motherboard data has been initialized and compares the personalization data with the motherboard data if the motherboard data has been initialized; and
an initialization module that initializes the motherboard data with the personalization data if the motherboard data has not been initialized and terminates the boot sequence if the motherboard data does not match the personalization data
wherein the access module, the analysis module, and the initialization module comprise one or more of logic hardware and executable code, the executable code stored on one or more computer-readable storage media.

2. The apparatus of claim 1, wherein the personalization data further comprises writeable data that is not compared with the motherboard data.

3. The apparatus of claim 2, wherein the writeable data comprises system data comprising firmware data comprising Complementary Metal Oxide Semiconductor (“CMOS”) data.

4. The apparatus of claim 2, wherein the writeable data comprises user-definable data.

5. The apparatus of claim 1, wherein the personalization data comprises one or more of machine type, model, serial number, universal unique identifier, operating system marker(s), Advanced Encryption Standard enablement, Active Management Technology enablement, and Trusted Platform Module enablement.

6. A system comprising:
a removable storage device that stores personalization data;
a computer having a motherboard socket configured to receive the removable storage device;
an access module that detects whether the removable storage device is installed in the motherboard socket during a boot sequence of the computer and reads the personalization data from the removable storage device if installed;
an analysis module that determines if motherboard data has been initialized and compares the personalization data with the motherboard data if the motherboard data has been initialized; and
an initialization module that initializes the motherboard data with the personalization data if the motherboard data has not been initialized and terminates the computer boot sequence if the motherboard data does not match the personalization data
wherein the access module, the analysis module, and the initialization module comprise one or more of logic hardware and executable code, the executable code stored on one or more computer-readable storage media.

7. The system of claim 6, further comprising a programming module that stores the personalization data into the removable storage device in a secure vendor-controlled manner, wherein the programming module comprises one or more of logic hardware and executable code, the executable code stored on one or more computer-readable storage media.

8. The system of claim 7, wherein the secure vendor-controlled manner comprises encrypting the personalization data.

9. The system of claim 6, further comprising a reset module that clears initialization of the motherboard data in a secure vendor-controlled manner, wherein the reset module comprises one or more of logic hardware and executable code, the executable code stored on one or more computer-readable storage media.

10. The system of claim 6, further comprising a physically lockable part that locks the removable storage device into the motherboard socket in a secure vendor-controlled manner.

11. A computer program product comprising a computer readable storage medium storing a computer readable program code executed to perform operations for motherboard personalization, the operations of the computer program product comprising:
detecting whether a removable storage device that stores personalization data is installed in a motherboard socket during a boot sequence of a computer;
reading the personalization data from the removable storage device if installed;
determining if motherboard data has been initialized;
comparing the personalization data with the motherboard data if the motherboard data has been initialized;
initializing the motherboard data with the personalization data if the motherboard data has not been initialized; and
terminating the boot sequence if the motherboard data does not match the personalization data.

12. The computer program product of claim 11, further comprising the operation of writing writeable data that is not compared with the motherboard data into the removable storage device, the writeable data comprising one or more of system data and user-definable data.

13. A machine-implemented method comprising:
detecting whether a removable storage device that stores personalization data is installed in a motherboard socket during a boot sequence of a computer;
reading the personalization data from the removable storage device if installed;
determining if motherboard data has been initialized;
comparing the personalization data with the motherboard data if the motherboard data has been initialized;
initializing the motherboard data with the personalization data if the motherboard data has not been initialized; and
terminating the boot sequence if the motherboard data does not match the personalization data.

14. The method of claim 13, wherein the method further comprises writing writeable data that is not compared with the motherboard data into the removable storage device, the writeable data comprising one or more of system data and user-definable data.

15. The method of claim 13, wherein the writeable data can be written only once.

16. The method of claim 13, wherein the method further comprises programming the removable storage device by storing the personalization data into the removable storage device in a secure vendor-controlled manner.

17. The method of claim 16, wherein the personalization data can be stored only once.

18. The method of claim 16, wherein storing further comprises encrypting the personalization data.

19. The method of claim 13, wherein reading further comprises decrypting the personalization data

20. The method of claim 13, wherein the method further comprises clearing initialization of the motherboard data in a secure vendor-controlled manner.
